(19) United States
(12) Patent Application Publication
(10) Pub. No.: US 2004/0054025 A1
(43) Pub. Date: Mar. 18, 2004

(54) Compositions comprising a benzophenone photoinitiator

(76) Inventor: John A. Lawton, Landenberg, PA (US)

Correspondence Address: PILLSBURY WINTHROP, LLP, P.O. BOX 10500, MCLEAN, VA, 22102, US

(21) Appl. No.: 10/617,362

(22) Filed: Jul. 11, 2003

Related U.S. Application Data
(63) Continuation-in-part of application No. PCT/NL02/00408, filed on Jun. 20, 2002.
(60) Provisional application No. 60/415,514, filed on Oct. 3, 2002.

(51) Int. Cl. C08G 2/00; C08F 2/46

(52) U.S. Cl. 522/168; 522/178

(57) ABSTRACT

The present invention provides compositions having a benzophenone photoinitiator. In addition, the present invention provides applications for these compositions, for instance in a rapid prototyping process to form a three-dimensional article.

### FIELD OF THE INVENTION

The present invention relates to compositions comprising a benzophenone photoinitiator. In addition, the present invention relates to applications for such compositions, such as their use in rapid prototyping processes.

### BACKGROUND

In the field of curable compositions, aging stability is generally a relevant parameter. For instance, a cured article may yellow over time, which is undesirable in a wide variety of applications, for instance because it may decrease the transparency of the article. One of the objectives of the present invention is to decrease these undesirable effects.

Examples of curable compositions are set forth in. for instance, U.S. Pat. No. 5,352,712; U.S. Pat. No. 5,418,112; U.S. Pat. No. 5,434,196; U.S. Pat. No. 5,476,748; U.S. Pat. No. 5,476,749; U.S. Pat. Nos. 5,707,780; 5,849,459; U.S. Pat. No. 5,972,563; U.S. Pat. No. 6,136,497; U.S. patent application Ser. No. 09/379,781; U.S. patent application Ser. No. 10/091,119; and European Application 0360869; all of which are hereby incorporated in their entirety by reference.

### SUMMARY

The present invention provides, inter alia, compositions having a benzophenone photoinitiator.

In one embodiment, the present invention provides a composition comprising, as pre-mixture ingredients,

(i) at least one free radical curable component;

(ii) at least one cationically curable component;

(iii) at least one free radical photoinitiator selected from the group consisting of benzophenones; and

(iv) at least one other free radical photoinitiator not selected from the group consisting of benzophenones.

In another embodiment, the present invention provides a composition comprising, as pre-mixture ingredients,

(i) at least one free radical curable component; and

(ii) 0.01 to less than 0.50 wt % of a free radical photoinitiator selected from the group consisting of benzophenones.

### BRIEF DESCRIPTION OF THE FIGURES

FIG. 1 depicts curves representing the transparency of a cured composition versus the benzophenone content of the composition.

FIG. 2 depicts curves representing the color transparency of a composition versus the exposure time to radiation.

### DESCRIPTION

Preliminary remarks: “pre-mixture ingredients” corresponds to the identity of components used for the present compositions prior to combining these components to form the present compositions. Accordingly, reactions that may occur between the several components after combining them are not taken into consideration.

The term “(meth)acrylate” is understood herein to include an acrylate and/or methacrylate.

### (i) Free Radical Polymerizable Components

The present compositions comprise one or more free radical polymerizable components. The free radical polymerizable component may be monofunctional (i.e. comprise one free radical polymerizable group per molecule) or polyfunctional (i.e. comprise more than one free radical polymerizable group per molecule). In one embodiment, the compatible component comprises at least two free radical polymerizable groups, for instance 2, 3, 4, 5, or 6 free radical polymerizable groups. The free radical polymerizable groups may be (meth)acrylate groups, for instance acrylate groups. Non-exhaustive examples of free radical polymerizable components suitable for use in the present compositions are listed below.

Suitable as the acrylic component are, for example, diacrylates of cycloaliphatic or aromatic diols, such as 1,4-dihydroxymethylcyclohexane, 2,2-bis(4-hydroxycyclohexyl)propane, 1,4-cyclohexanedimethanol, bis(4-hydroxycyclohexyl)methane, hydroquinone, 4,4-dihydroxybiphenyl, bisphenol A, bisphenol F, bisphenol S, and combinations thereof.

In one embodiment, the compositions comprise a free radical polymerizable component having a functionality greater than 2 as the additional free radical polymerizable component. These can be for example, tri, tetra, penta, or hexafunctional monomeric or oligomneric aliphatic (meth)acrylates.

Suitable as aliphatic polyfunctional (meth)acrylates are, for example, the triacrylates and trimethacrylates of hexane-2,4,6-triol, glycerol, or 1,1,1-trimethylolpropane, or 1,1,1-trimethylolpropane and hydroxy group-containing tri(meth)acrylates which are obtained by, for instance, the reaction of triepoxy compounds with (meth)acrylic acid. It is also possible to use, for example, (meth)acrylate-functional pentaerythritol derivates, such as, for instance, pentaerythritol tri(meth)acrylate, dipentaerythritolpenta(meth)acrylate, or dipentaerythritolhexa(meth)acrylate. (Meth)acrylate-functional neopentyl glycol derivatives, e.g. alkoxylated neopentyl glycol di(meth)acrylates, are also suitable for use in the present compositions.

It is also possible to use hexafunctional urethane (meth)acrylates. Those urethane (meth)acrylates are known to the person skilled in the art and can be prepared in known manner, for example by reacting a hydroxy-terminated polyurethane with acrylic acid or methacrylic acid, or by reacting an isocyanate-terminated prepolymer with hydroxyalkyl (meth)acrylates to form the urethane (meth)acrylate.

Hydroxyfunctional free radical polymerizable ester components have also been found to be useful in certain embodiments. An example is, for instance, caprolactone acrylate. In one embodiment, the present compositions comprise 0-8 wt % of caprolactone acrylate. In another embodiment, the present compositions comprise 0-3 wt % of caprolactone acrylate. In an even further embodiment, the present compositions are absent caprolactone acrylate.

In one embodiment, the compositions comprise at least one free radical polymerizable component having a certain quantity of ether groups. An ether group according to the present invention is a group represented by the following formula (1):

—(R—O)— (1)

wherein

R represents a branched or unbranched, cyclic or non-cyclic aliphatic group comprising from 1-10 carbon atoms, preferably 2-6 carbon atoms, more preferably 2-4 carbon atoms, and most preferably 2-3 carbon atoms. Preferably, R consists of carbon atoms and hydrogen atoms, but in certain embodiments some or all of these hydrogen atoms may be replaced with other atoms, preferably monovalent atoms, such as for instance halogen atoms. Preferably, R is non-cyclic. The oxygen in formula (1) is bonded to a group other than hydrogen (“H”) or carbonyl (“C═O”). Preferably the oxygen in formula (1) is bonded, besides to “R”, to a cyclic or non-cyclic aliphatic hydrocarbon group or an aromatic ring.

In one embodiment, the free radical polymerizable component comprises at least one C₁-C₁₀ ether group, for instance at least one C₂-C₈ ether group or at least one C₂-C₄ ether group.

Free radical polymerizable components that are absent an aromatic ring-structure and that comprise at least one, for instance at least two, ether groups are also suitable for use in the present compositions. Preferably the non-aromatic component comprising at least two ether groups comprises at least one ether group per free radical polymerizable group.

Monofunctional components that may be used as the non-aromatic component include, for instance alkoxylated isodecyl acrylate, alkoxylated isobornyl acrylate, and alkoxylated lauryl acrylate. Examples of suitable non-aromatic compatible polyfunctional components include, for instance, tripropyleneglycol diacrylate, polypropyleneglycol dimethacrylate, alkoxylated neopentylglycol diacrylate, alkoxylated alkanediol diacrylates (e.g. ethoxylated or propoxylated hexanediol diacrylate), and alkoxylated trimethylolpropane triacrylate. Also oligomeric components may be used, such as, for instance, polytetrahydrofuran poly(meth)acrylates, poly(oxyethylene-oxypropylene) random or block copolymer poly(meth)acryalates, and poly(oxyethylene-oxybutylene) random or block copolymer poly(meth)acrylates. The number average molecular weight M, of the oligomeric components is preferably between 250-5000 g/mol, more preferably between 250-2000 g/mol, and most preferably between 250-1250 g/mol.

In one embodiment, the non-aromatic free radical polymerizable components are not only absent aromatic ring structures but are also absent aliphatic ring structures.

Non-aromatic free radical polymerizable components include those represented by the following formula (2):

X-[(O—R)ₘ—A]ₙ (2)

wherein

X represents a branched or unbranched aliphatic group comprising 1-10 carbon atoms, preferably 1-6 carbon atoms, more preferably 3-5 carbon atoms;

n represent an integer from 1 to 6, preferably 2-4, more preferably 2-3;

each R independently represents a branched or unbranched, cyclic or non-cyclic aliphatic group comprising from 1-10 carbon atoms, preferably 2-6 carbon atoms, more preferably 2-4 carbon atoms, and most preferably 2-3 carbon atoms. Preferably, R consists of carbon atoms and hydrogen atoms, but in certain embodiments some or all of these hydrogen atoms may be replaced with other atoms, preferably monovalent atoms, such as for instance halogen atoms.

Preferably, R is non-cyclic;

each m independently represents an integer from 0-10, preferably 1-5, more preferably 1-3;

at least one m represents an integer of at least 1, preferably at least 2;

each A independently represents a free radical polymerizable group, preferably a (meth)acrylate group, more preferably an acrylate group.

For instance, if n represents 2, then formula (2) comprises components represented by the following formula (3):

A—(R—O)ₘ—X—(O—R)ₘ—A (3)

wherein each A may be the same or different, each m may be the same or different, and each R may be the same or different.

A specific example of a component where n represents 2 is, for instance, propoxylated (1+1) neopentylglycol diacrylate:

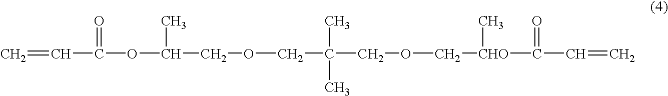

(i)(2): Aromatic Free Radical Polymerizable Components Comprising Ether Groups.

Aromatic components comprising one or more ether groups may be used in the present compositions. In one embodiment, it is preferred that the aromatic components comprise at least four ether groups. In a further embodiment, the aromatic component comprises more than two ether groups per free radical curable group, more preferably at least 4 ether groups per free radical curable group.

Monofunctional aromatic compatible components that may be used include, for instance, alkoxylated alkyl phenol acrylates (e.g. ethoxylated or propoxylated nonylphenol acrylate). Polyfunctional aromatic compatible components may also be used, for instance components represented by the following formula (5):

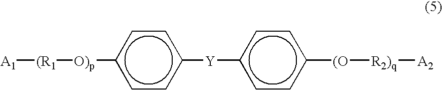

wherein

A₁ and A₂ independently represent a free radical polymerizable group, preferably a (meth)acrylate group, more preferably an acrylate group;

R₁ and R₂ independently represents a group according to R (as defined above).

p represents an integer from 0 to 30, for instance 2 to 15 or 4 to 15.

q represents an integer from 0 to 30, for instance 2 to 15 or 4 to 15.

p+q is preferably at least 5, for instance at least 8 or at least 12; and

Y represents a branched or unbranched aliphatic group comprising 1-10 carbon atoms, for instance 1-6 carbon atoms, 3-5 carbon atoms, or 3 carbon atoms.

An example of a compound represented by formula (5) is, for instance, ethoxylated (4+4) bisphenol A diacrylate:

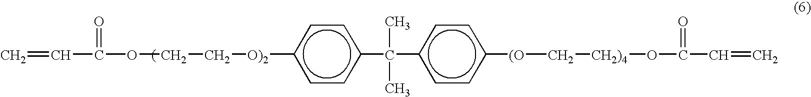

If present, the present compositions generally comprise, relative to the total weight of the composition, more than 2 wt % of free radical polymerizable component having one or more ether groups, e.g. at least 3 wt % or at least 5 wt %. The present compositions generally comprise, relative to the total weight of the composition, at most 60 wt % of free radical polymerizable component having one or more ether groups, e.g at most 30 wt %, at most 15 wt %, or at most 10 wt %.

Overall, the compositions generally comprise, relative to the total weight of the composition, at least 5 wt % of at least one free radical polymerizable component, e.g. at least 10 wt % or at least 15 wt %. Overall, the compositions generally comprise, relative to the total weight of the composition, less than 70 wt % of at least one free radical polymerizable component, e.g. less than 50 wt %, less than 30 wt %, or less than 20 wt %.

### (ii) Cationically Curable Component

The present invention may comprise a suitable cationically polymerizable component, such as, for instance, an epoxide-containing compound.

Epoxide-containing materials, also referred to as epoxy materials, are cationically curable, by which is meant that polymerization and/or crosslinking and other reactions of the epoxy group can be initiated by cations. These materials may be monomers, oligomers or polymers and are sometimes referred to as “resins.” Such materials may have an aliphatic, aromatic, cycloaliphlatic, arylaliphatic or heterocyclic structure; they can comprise epoxide groups as side groups or groups that form part of an alicyclic or heterocyclic ring system. Epoxy resins of those types include those that are generally known and are commercially available.

The composition may contain one or more epoxy resins. Preferably, the composition will comprise at least one liquid (at room temperature, 23° C.) component such that the combination of materials is a liquid. Thus, the epoxide-containing material is preferably a single liquid epoxy material, a combination of liquid epoxy materials, or a combination of liquid epoxy material(s) and solid epoxy material(s) which is soluble in the liquid. However, in certain embodiments, e.g. in embodiments where the epoxide material is soluble in other components of the composition, the epoxide material may be comprised only of materials that are solid at room temperature. When solid compositions are used, the compositions may be thinned or liquefied by applying shear and/or heat prior to or during use.

Examples of suitable epoxy materials include polyglycidyl and poly(methylglycidyl) esters of polycarboxylic acids, or poly(oxiranyl) ethers of polyethers. The polycarboxylic acid can be aliphatic, such as, for example, glutaric acid, adipic acid and the like; cycloaliphatic, such as, for example, tetrahydrophthalic acid; or aromatic, such as, for example, phthalic acid, isophthalic acid, trimellitic acid, or pyromellitic acid. The polyether can be poly(tetramethylene oxide).

Suitable epoxy materials also include polyglycidyl or poly(-methylglycidyl) ethers obtainable by the reaction of a compound having at least one free alcoholic hydroxy group and/or phenolic hydroxy group and a suitably substituted epichlorohydrin. The alcohols can be acyclic alcohols, such as, for example, ethylene glycol, diethylene glycol, and higher poly(oxyethylene) glycols; cycloaliphatic, such as, for example, 1,3- or 1,4-dihydroxycyclohexane, bis(4-hydroxycyclohexyl)methane, 2,2-bis(4-hydroxycyclohexyl)propane, or 1,1-bis(hydroxymethyl)cyclohlex-3-ene; or contain aromatic nuclei, such as N,N-bis(2-hydroxyethyl)aniline or p,p′-bis(2-hydroxyethylamino)diphenylmethane.

Other suitable epoxy compounds include those which may be derived from mono nuclear phenols, such as, for example, resorcinol or hydroquinone, or they may be based on polynuclear phenols, such as, for example, bis(4-hydroxyphenyl)methane (bisphenol F), 2,2-bis(4-hydroxyphenyl)propane (bisphenol A), or on condensation products, obtained under acidic conditions, of phenols or cresols with formaldehyde, such as phenol novolacs and cresol novolacs.

Suitable epoxy materials also include poly(N-glycidyl) compounds, which are, for example, obtainable by dehydrochorination of the reaction products of epichlorohydrin with amines that comprise at least two amine hydrogen atoms, such as, for example, n-butylamine, aniline, toluidine, m-xylylene diamine, bis(4-aminophenyl)methane or bis(4-methylaminophenyl)methane. Suitable poly(N-glycidyl) compounds also include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin.

Examples of suitable epoxy materials include poly(S-glycidyl) compounds which are di-S-glycidyl derivatives which are derived from dithiols, such as, for example, ethane-1,2-dithiol or bis(4-mercaptomethylphenyl)ether.

Preferred epoxide-containing materials include those selected from the group consisting of bis(2,3-epoxycyclopentyl)ether, 2,3-epoxy cyclopentyl glycidyl ether, 1,2-bis(2,3-epoxycyclopentyloxy)ethane, bis(4-hydroxycyclohexyl)methane diglycidyl ether, 2,2-bis(4-hydroxycyclohexyl)propane diglycidyl ether, 3,4-epoxycyclohexylmethyl-3,4-epoxycyclohexane, 3,4-epoxy-6-methylcyclohexylmethyl-3,4-epoxy-6-methylcyclohexanecaboxylate, di(3,4-epoxycyclohexylmethyl)hexanedioate, di(3,4-epoxy-6-methylcyclohexylmethyl)hexanedioate, ethylenebis(3,4-epoxycyclohexanecarboxylate), ethanedioldi(3,4-epoxycyclohexylmethyl)ether, vinylcyclohexene dioxide, dicyclopentadiene diepoxide, α-(oxiranylmethyl)-ω-(oxiranylmethoxy)poly(oxy-1,4-butanediyl), diglycidyl ether of neopentyl glycol, or 2-(3,4-epoxycyclohexyl-5,5-spiro-3,4-epoxy)cyclohexane-1,3-dioxane, and combinations thereof.

It is, however, also possible to use epoxy resins in which the 1,2-epoxy groups are bonded to different heteroatoms or functional groups. Those compounds include, for example, the N,N,O-triglycidyl derivative of 4-aminophenol, the glycidyl ether glycidyl ester of salicylic acid, N-glycidyl-N′-(2-glycidyloxypropyl)-5,5-dimethylhydantoin, or 2-glycidyloxy-1,3-bis(5,5-dimethyl-1-glycidylhydantoin-3-yl)propane. In addition, liquid prereacted adducts of such epoxy resins with hardeners are suitable for epoxy resins.

It is preferred that the composition comprises at least one cycloaliphatic epoxide, for instance a cycloaliphatic diepoxide. Accordingly, the compositions may comprise an epoxy component having at least one cyclohexeneoxide structure, for instance at least 2 cyclohexeneoxide structures.

The epoxy materials can have molecular weights which vary over a wide range. In general, the epoxy equivalent weight, i.e., the number average molecular weight divided by the number of reactive epoxy groups, is preferably in the range of 60 to 1000.

Other cationically polymerizable components that may be used in the composition of the present invention include, for instance, cyclic ether compounds, cyclic lactone compounds, cyclic acetal compounds, cyclic thioether compounds, spiro orthoester compounds, and oxetane compounds. Examples of oxetane compounds include compounds represented by the following formula (8):

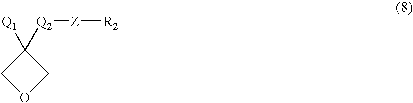

wherein

Q₁ represents a hydrogen atom, an alkyl group having 1 to 6 carbon atoms (such as a methyl, ethyl, propyl, or butyl group), a fluoroalkyl group having 1 to 6 carbon atoms, an allyl group, an aryl group, a furyl group, or a thienyl group;

Q₂ represents an alkylene group having 1 to 6 carbon atoms (such as a methylene, ethylene, propylene, or butylene group), or an alkylene group containing an either linkage, for example, an oxyalkylene group, such as an oxyethylene, oxypropylene, or oxybutylene group

Z represents an oxygen atom or a sulphur atom; and

R₂ represents a hydrogen atom, an alkyl group having 1-6 carbon atoms (e.g. a methyl group, ethyl group, propyl group, or butyl group), an alkenyl group having 2-6 carbon atoms (e.g. a 1-propenyl group, 2-propenyl group, 2-methyl-1-propenyl group, 2-methyl-2-propenyl group, 1-butenyl group, 2-butenyl group, or 3-butenyl group), an aryl group having 6-18 carbon atoms (e.g. a phenyl group, naphthyl group, anthranyl group, or phenanthryl group), a substituted or unsubstituted aralkyl group having 7-18 carbon atoms (e.g. a benzyl group, fluorobenzyl group, methoxy benzyl group, phenethyl group, styryl group, cynnamyl group, ethoxybenzyl group), an aryloxyalkyl group (e.g. a phenoxymethyl group or phenoxyethyl group), an alkylcarbonyl group having 2-6 carbon atoms (e.g. an ethylcarbonyl group, propylcarbonyl group, or butylcarbonyl group), an alkoxy carbonyl group having 2-6 carbon atoms (e.g. an ethoxycarbonyl group, propoxycarbonyl group, or butoxycarbonyl group), an N-alkylcarbamoyl group having 2-6 carbon atoms (e.g. an ethylcarbamoyl group, propylcarbamoyl group, butylcarbamoyl group, or pentylcarbamoyl group), or a polyethergroup having 2-1000 carbon atoms.

Preferred oxetanes include those wherein Q₁ represents a C₁-C₄ alkyl group (e.g. an ethyl group), Z represents an oxygen atom, Q₂ represents a methylene group, and/or R₂ represents a hydrogen atome, a C₁-C₈ alkyl group, a phenylgroup, 3-ethyl-3-hydroxymethyloxetane, (3-ethyl-3-oxetanylmethoxy)methylbenzene, (3-ethyl-3-oxetanylmethoxy)benzene, 2-ethylhexyl (3-ethyl-3-oxetanyl methyl) ether, 1,4-bis[(3-ethyl-3-oxetanylmethoxy)methyl]benzene, 2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether or bis(3-ethyl-3-oxetanylmethyl) ether.

Some further examples of oxetane compounds include the following:

Oxetane compounds containing one oxetane ring in the molecule include, for instance, 3-ethyl-3-hydroxymethyloxetane, 3-(meth)allyloxymethyl-3-ethyloxetane, (3-ethyl-3-oxetanylmethoxy)methylbenzene, (3-ethyl-3-oxetanylmethoxy)benzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl -3-oxetanylmethoxy)ethyl] phenyl ether, isobutoxymethyl (3-ethyl-3-oxetanylmethyl) ether, isobornyloxyethyl (3-ethyl-3-oxetanylmethyl) ether, isobrnyl (3-ethyl-3-oxetanylmethyl) ether, 2-ethylhexyl (3-ethyl-3-oxetanyl methyl) ether, ethyldiethylene glycol (3-ethyl-3-oxetanylmethyl) ether, dicyclopentadiene (3-ethyl-3-oxetanylmethyl) ether, dicyclopentenyloxyethyl (3-ethyl-3-oxetanyl methyl) ether, dicyclopentenyl (3-ethyl-3-oxetanylmethyl) ether, tetrahydrofurfuryl (3-ethyl-3-oxetanylmethyl) ether, tetrabromophenyl (3-ethyl-3-oxetanylmethyl) ether, 2-tetrabromophenoxyethyl (3-ethyl-3-oxetanylmethyl) ether, tribromophenyl (3-ethyl-3-oxelanylmethyl) ether, 2-tribromophenoxyethyl (3-ethyl-3-oxetanylmethyl) ether, 2-hydroxyethyl (3-ethyl-3-oxetanyl methyl) ether, 2-hydroxypropyl (3-ethyl-3-oxetanylmethyl) ether, butoxyethyl (3-ethyl-3-oxetanylmethyl) ether, pentachlorophenyl (3-ethyl-3-oxetanylmethyl) ether, pentabromophenyl (3-ethyl-3-oxetanylmethyl) ether, bornyl (3-ethyl-3-oxetanylmethyl) ether.

Oxetane compounds containing two or more oxetane ring in the molecule include, for instance, 3,7-bis(3-oxetanyl)-5-oxa-nonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[ (3-ethyl-3-oxetanylmethoxy)methyl]ethane, 1,3-bis[(3-ethyl-3-oxetanymethoxy)methy]propane, ethylene glycol bis(3-ethyl-3-oxetanylmethyl) ether, dicyclopentenyl bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, tricyclodecanediyldimethylene (3-ethyl-3-oxetanylmethyl) ether, trimethylolpropane tris(3-ethyl-3-oxetanylmethyl) ether, 1,4-bis(3-ethyl-3-oxetanylmethoxy)butane, 1,6-bis(3-ethyl-3-oxetanylmethloxy)hexane, pentaerythritol tris(3-ethyl-3-oxetanylmethyl) ether, pentaerythritol tetrakis(3-ethyl-3-oxetanylmethyl) ether, polyethylene glycol bis(3-ethyl-3-oxetanylmethyl) ether, dipentaerythritol hexakis(3-ethyl-3-oxetanylmethyl) ether, dipentaerythritol pentakis(3-ethyl-3-oxetanylmethyl) ether, dipentaerythritol tetrakis(3-ethyl -3-oxetanylmethyl) ether, caprolactone-modified dipentaerythritol hexakis(3-ethyl-3-oxetanylmethyl) ether, caprolactone-modified dipentaerythritol pentakis(3-ethyl-3-oxetanylmethyl) ether, ditrimethylolpropane tetrakis(3-ethyl-3-oxetanylmethyl) ether, EO-modified bisphenol A bis(3-ethyl-3-oxetanylmethyl) ether, PO-modified bisphenol A bis(3-ethyl-3-oxetanylmethyl) ether, EO-modified hydrogenated bisphenol A bis(3-ethyl-3-oxetanylmethyl ether, PO-modified hydrogenated bisphenol A bis(3-ethyl-3-oxetanylmethyl) ether, EO-modified bisphenol F (3-ethyl-3-oxetanylmethyl) ether. It is of course possible to use mixtures of cationically polymerizable components in the compositions according to the invention.

If present, the composition of the present invention comprises, relative to the total weight of the composition, preferably at least 10 wt %, e.g. at least 20 wt %, at least 30 wt %, or at least 45 wt % of cationically curable components. Preferably the composition of the invention comprises, relative to the total weight of the composition, less than 95 wt %, e.g. less than) 85 wt % or less than less than 70 wt % of cationically curable components.

### (iii) Free Radical Photoinitiator Selected From the Group Consisting of Benzophenones

The present compositions comprise at least one free radical photoinitiator selected from the group consisting of benzophenones. Examples of benzophenones include, for instance, benzophenone, alkyl-substituted benzophenone (e.g. 2-methylbenzophenone, 3-methylbenzophenone, or 4-methylbenzophenone), alkoxy-substituted benzophenone (e.g. 4-methoxybenzophenone), 4-morpholinobenzophenone, and 4,4′-bis(N,N′-dimethylamino)-benzophenone. Further examples are disclosed in, for instance, U.S. Pat. Nos. 4,043,887; 5,264,533; 5,418,112; and 6,207,727; which are all four hereby incorporated in their entirety by reference. The benzophenone photoinitiators are preferably absent a hydroxy group. The at least one free radical photoinitiator selected from the group consisting of benzophenones is generally present in the compositions in an amount of, relative to the total weight of the composition, less than 5 wt %, e.g. less than 2.5 wt %, less than 1.5 wt %, less than 0.5 wt %, less than 0.3 wt %, less than 0.1 wt %, or less than 0.08 wt %. The amount will generally be above 0.01 wt %, e.g. above 0.03 wt %.

### (iv) Free Radical Photoinitiator Not Selected From the Group Consisting of Benzophenones

The compositions may, in addition, employ one or more other free radical photoinitiators (i.e. photoinitiators not selected from the group consisting of benzophenones). Typical compounds of such other photoinitiators are benzoins, e.g. benzoin, benzoin ethers, such as benzoin methyl ether, benzoin ethyl ether, and benzoin isopropyl ether, benzoin phenyl ether, and benzoin acetate; acetophenones, such as acetophenones, 2,2-dimethoxyacetophenone, 4-(phenylthio)acetophenone, and 1,1-dichloroacetophenone; benzil, benzil ketals, such as benzil dimethyl ketal, and benzil diethyl ketal; anthraquinones, such as 2-methylanthraquinone 2-ethylanthraquinone, 2-tertbutylanthraquinone, 1-chloroanthraquinone, and 2-amylanthraquinone; triphenylphosphine, benzoylphosphine oxides, such as, for example, 2,4,6-trimethylbenzoyldiphenylphosphine oxide (Lucirin TPO); thioxanthones and xanthones, acridine derivatives, phenazene derivatives, quinoxaline derivatives or 1-phenyl-1,2-propanedione-2-O-benzoyloxime, 1-aminophenyl ketones or 1-hydroxyphenyl ketones, such as 1-hydroxycycloloexyl phenyl ketone, phenyl (1-hydroxyisopropyl)ketone and 4-isopropylphenyl(1-hydroxyisopropyl)ketone, or triazine compounds, for example, 4′″-methyl thiophenyl-1-di(trichloromethyl)-3,5-S-triazine, S-triazine-2-(stilbene)-4,6-bistrichloromethyl, and paramethoxy styryl triazine. Preferred “other free radical photoinitiators” include the group of 1-hydrophenyl ketones, e.g. 1-hydroxycycloloexyl phenyl ketone.

Another class of suitable other free radical photoinitiators comprises the ionic dye-counter ion compounds, which are capable of absorbing actinic rays and producing free radicals, which can initiate the polymerization of the acrylates. The compositions according to the invention that comprise ionic dye-counter ion compounds can thus be cured in a more variable manner using visible light in an adjustable wavelength range of 400 to 700 nanometers. Ionic dye-counter ion compounds and their mode of action are known, for example from published European patent application EP 223587 and U.S. Pat. Nos. 4,751,102, 4,772,530 and 4,772,541. There may be mentioned as examples of suitable ionic dye-counter ion compounds the anionic dye-iodonium ion complexes, the anionic dye-pyryllium ion complexes and, especially, the cationic dye-borate anion compounds of the following formula (7)

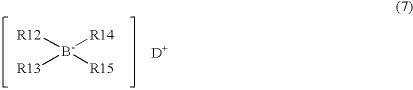

wherein D⁺ is a cationic dye and R₁₂, R₁₃, R₁₄, and R₁₅ are each independently of the others alkyl aryl, alkaryl, allyl, aralkyl, alkenyl, alkynyl, an alicyclic or saturated or unsaturated heterocyclic group. Preferred definitions for the radicals R₁₂ to R₁₅ can be found, for example, in published European patent application EP 223587.

If the composition comprises at least one “other” free radical photoinitiator, the weight ratio of the at least one photoinitiator selected from the group of benzophenones to the at least one other photoinitiator (i.e. the weight of benzophenone photoinitiators divided by the weight of other photoinitiators) is preferably less than 0.50, for instance less than 0.35, less than 0.25, less than 0.15, less than 0.10, or less than 0.05. The weight ratio will generally be greater than 0.01.

### (v) Hydroxy-functional Components

The present compositions may comprise suitable hydroxy-functional compounds. The hydroxy-functional components may be absent free radical polymerizable groups, epoxy groups, and/or oxetane groups.

The hydroxyl-containing material which can be used in the present invention may be any suitable organic material having a hydroxyl functionality of at least 1 (“monol”), and preferably at least 2 (“polyol”). The material is preferably substantially free of any groups which interfere with the curing reactions or which are thermally or photolytically unstable.

In one embodiment, the hydroxyl-containing material contains two or more primary or secondary aliphatic hydroxyl groups. The hydroxyl group may be internal in the molecule or terminal. The hydroxyl equivalent weight, i.e., the number average molecular weight divided by the number of hydroxyl groups, may vary and may be, for instance, in the range of 31 to 5000.

Representative examples of hydroxyl-containing materials having a hydroxyl functionality of 1 include alkanols, monoalkyl ethers of polyoxyalkyleneglycols, monoalkyl ethers of alkyleneglycols, and others, and combinations thereof.

Representative examples of useful polyhydroxy organic materials include alkylene and arylalkylene glycols, such as 1,2,4-butanetriol, 1,2,6-hexanetriol, 1,2,3-heptanetriol, 2,6-dimethyl-1,2,6-hexanetriol, (2R,3R)-(−)-2-benzyloxy-1,3,4-butanetriol, 1,2,3-hexanetriol, 1,2,3-butanetriol, 3-methyl-1,3,5-pentanetriol, 1,2,3-cyclohexanetriol, 1,3,5-cyclohexanetriol, 3,7,11,15-tetramethyl-1,2,3-hexadecanetriol, 2-hydroxymethyltetrahydropyran-3,4,5-triol, 2,2,4,4-tetramethyl-1,3-cyclobutanediol, 1,3-cyclopentanediol, trans-1,2-cyclooctanediol, 1,16-hexadecanediol, 3,6-dithia-1,8-octanediol, 2-butyne-1,4-diol, 1,3-propanediol, 1,4-butanediol, 1,5-pentanediol, 1,6-hexanediol, 1,7-heptanediol, 1,8-octanediol, 1,9-nonanediol, 1-phenyl-1,2-ethanediol, 1,2-cyclohexanediol, 1,5-decalindiol, 2,5-dimethyl-3-hexyne-2,5-diol, 2,7-dimethyl-3,5-octadiyne-2-7-diol, 2,3-butanediol, 1,4-cyclohexanedimethanol, and combinations thereof.

Representative examples of useful oligomeric and polymeric hydroxyl-containing materials include polyoxyethylene and polyoxypropylene glycols and triols of molecular weights from about 200 to about 10,000; polytetramethylene glycols of varying molecular weight; poly(oxyethylene-oxybutylene) random or block copolymers; copolymers containing pendant hydroxy groups formed by hydrolysis or partial hydrolysis of vinyl acetate copolymers, polyvinylacetal resins containing pendant lydroxyl groups; hydroxy-functional (e.g. hydroxy-terminated) polyesters and hydroxy-functional (e.g. hydroxy-terminated) polylactones; hydroxy-functionalized polyalkadienes, such as polybutadiene; aliphatic polycarbonate polyols, such as an aliphatic polycarbonate diol; and hydroxy-functional (e.g. hydroxy-terminated) polyethers (e.g. polytetrahydrofuran polyols in the range of 150-4000 g/mol, 150-1500 g/mol, or 150-750 g/mol), and combinations thereof.

If present, the composition preferably comprises, relative to the total weight of the composition, at least 1 wt % of hydroxy-functional compounds, e.g. at least 5 wt %, at least 10 wt %, or at least 15 wt %. Furthermore, the composition generally comprises, relative to the total weight of the composition, at most 75 wt % of one or more non-free radical polymerizable hydroxy-functional compounds, e.g. at most 50 wt %, at most 30 wt %, or at most 20 wt %.

### (vi) Cationic Photoinitiator

In the compositions according to the invention, any suitable type of photoinitiator that, upon exposure to actinic radiation, forms cations that initiate the reactions of the cationically polymerizable compounds, such as epoxy material(s), can be used. There are a large number of known and technically proven cationic photoinitiators that are suitable. They include, for example, onium salts with anions of weak nucleophilicity. Examples are halonium salts, iodosyl salts or sulfonium salts, such as are described in published European patent application EP 153904 and WO 98/28663, sulfoxonium salts, such as described, for example, in published European patent applications EP 35969, 44274, 54509, and 164314, or diazonium salts, such as described, for example, in U.S. Pat. Nos. 3,708,296 and 5,002,856. All eight of these disclosures are hereby incorporated in their entirety by reference. Other cationic photoinitiators are metallocene salts, such as described, for example, in published European applications EP 94914 and 94915, which applications are both hereby incorporated in their entirety by reference.

A survey of other current onium salt initiators and/or metallocene salts can be found in “UV Curing, Science and Technology”, (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring), and both books are hereby incorporated in their entirety by reference.

Preferred initiators include diaryl iodonium salts, triaryl sulfonium salts, or the like. Typical photo-polymerization initiators include those represented by the following formulae (9) and (10):

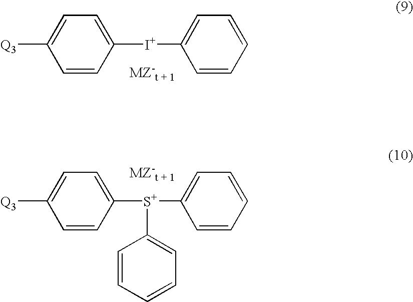

wherein

Q₃ represents a hydrogen atom, an alkyl group having 1 to 18 carbon atoms, or an alkoxyl group having 1 to 18 carbon atoms;

M represents a metal atom, preferably antimony;

Z represents a halogen atom, preferably fluorine; and

t is the valent number of the metal, for example 6 in the case of antimony.

Preferred cationic photoinitiators include iodonium photoinitiators, e.g. iodonium tetrakis (pentafluorophenyl) borate, because they tend to be less yellowing, especially when used in combination with photosensitizers such as, for instance, n-ethyl carbazole.

In order to increase the light efficiency, or to sensitize the cationic photoinitiator to specific wavelengths, such as for example specific laser wavelengths or a specific series of laser wavelengths, it is also possible, depending on the type of initiator, to use sensitizers. Examples are polycyclic aromatic hydrocarbons or aromatic keto compounds. Specific examples of preferred sensitizers are mentioned in published European patent application EP 153904. Other preferred sensitizers are benzoperylene, 1,8-diphenyl-13,5,7-octatetraene, and 1,6-diphenyl-1,3,5-hexatriene as described in U.S. Pat. No. 5,667,937, which is hereby incorporated in its entirety by reference. It will be recognized that an additional factor in the choice of sensitizer is the nature and primary wavelength of the source of actinic radiation.

Preferably, the present composition comprises, relative to the total weight of the composition, 0.1-15 wt % of one or more cationic photoinitiators, more preferably 1-10 wt %.

### (vii) Additives

Additives may also be present in the composition of the invention. Stabilizers are often added to the compositions in order to prevent a viscosity build-up, for instance a viscosity build-up during usage in a solid imaging process. Preferred stabilizers include those described in U.S. Pat. No. 5,665,792, the entire disclosure of which is hereby incorporated by reference. Such stabilizers are usually hydrocarbon carboxylic acid salts of group IA and IIA metals. Most preferred examples of these salts are sodium bicarbonate, potassium bicarbonate, and rubidium carbonate. Rubidium carbonate is preferred for formulations of this invention with recommended amounts varying between 0.0015 to 0.005% by weight of composition. Alternative stabilizers are polyvinylpyrrolidones and polyacrylonitriles. Other possible additives include dyes, pigments, fillers (e.g. silica particles -preferably cylindrical or spherical silica particles-, glass beads, or talc), antioxidants, wetting agents, photosensitizers for the free-radical photoinitiator, leveling agents, surfactants, and the like. For further improved reduction of color, the use of antioxidants such as, for example, Longnox 10 (Longchem Int.) and Irganox 1035 (Ciba Geigy) in ranges of 0.01-2% levels have been found to be effective in conjunction with the compounds of the instant invention.

### Applications

The present compositions are suitable for a wide variety of applications. For instance, the present compositions may be used as coating compositions (e.g. for optical fibers or displays), as adhesives (e.g. as adhesives for digital versatile discs), or as compositions for preparing a three dimensional object by rapid prototyping. The compositions may be cured by heat or any suitable form of radiation, e.g. electron beam radiation or actinic radiation, or mixtures thereof. For instance, the composition may first be cured to a certain extent by radiation and subsequently be post-cured by heat.

Rapid prototyping, sometimes also referred to as “solid imaging” or “stereolithography”, is a process wherein a photoformable liquid is coated into a thin layer upon a surface and exposed imagewise to actinic radiation such that the liquid solidifies imagewise. See, e.g., U.S. Pat. Nos. 5,476,748 and 5,707,780. This coating is most conveniently done if the composition is a liquid at room temperature, but a solid composition may also be melted to Finn a layer. Subsequently, new thin layers of photoformable liquids are coated onto previous layers of liquid or previously solidified sections. Then the new layer is exposed imagewise in order to solidify portions imagewise and in order to induce adhesion between portions of the new hardened region and portions of the previously hardened region. Each imagewise exposure is of a shape that relates to a pertinent cross-section of a photohardened object such that when all the layers have been coated and all the exposures have been completed, an integral photohardened object can be removed from the surrounding liquid composition.

Accordingly, a rapid prototyping process may for instance be described as:

(1) coating a thin layer of a composition onto a surface;

(2) exposing said thin layer imagewise to actinic radiation to form an imaged cross-section, wherein the radiation is of sufficient intensity to cause substantial curing of the thin layer in the exposed areas:

(3) coating a thin layer of the composition onto the previously exposed imaged cross-section;

(4) exposing said thin layer from step (3) imagewise to actinic radiation to form an additional imaged cross-section, wherein the radiation is of sufficient intensity to cause substantial curing of the thin layer in the exposed areas and to cause adhesion to the previously exposed imaged cross-section;

(5) repeating steps (3) and (4) a sufficient number of times in order to build up the three-dimensional article.

Furthermore, it has been found that benzophenones may be advantageously used to improve color stability. Accordingly, the present invention also provides a process for improving the color stability of an article formed at least in part by curing a composition, wherein the process comprises including a benzophenone-type photoinitiator, and optionally at least one other photoinitiator, in the composition prior to cure.

### EXAMPLES

The following examples are given as particular embodiments of the invention and to demonstrate the practice and advantages thereof. It is to be understood that the examples are given by way of illustration and are not intended to limit the specification or the claims that follow in any manner.

TABLE 1
Glossary

| Commercial Name (Supplier) | Description |
|---|---|
| Uvacure 1500 (UCB Radcure) | 3,4-Epoxy Cyclohexyl Methyl- |
| | 3,4-Epoxy Cyclohexyl Carboxylate |
| SR-399 (Sartomer) | Monohydroxy dipentaerythritol |
| | pentaacrylate |
| SR-9003 (Sartomer) | Propoxylated (1 + 1) |
| | neopentylglycol diacrylate |
| Irgacure 184 (Ciba Geigy) | 1-hydroxycyclohexyl phenyl ketone |
| Irganox 1035 (Ciba Geigy) | thiodiethylene bis(3,5-di-tert-butyl- |
| | 4-hydroxy hydrocinnamate) |
| CPI-6976 (Aceto) | Mixture of triarysulfonium |
| | hexafluoroantimonate salts |
| Terathane 250 (E.I. DuPont) | Polytetrahydrofuran polyol, |
| | Mw about 250 g/mol. |
| Silwet L-7600 (OSI Specialities) | Surfactant |
| BYK-088 (BYK-Chemie) | Defoamer |

The following compositions were prepared (quantities shown in wt %):

TABLE 2

| | Comp. A | Comp. B | Ex. 1 | Ex. 2 | Ex. 3 | Ex. 4 | Ex. 5 | Ex. 6 |
|---|---|---|---|---|---|---|---|---|
| Ingredients | | | | | | | | |
| Uvacure-1500 | 76.4 | 76.2 | 77.9 | 77.1 | 76.65 | 76.55 | 76.5 | 76.45 |
| SR-399 | 15 | 15 | 15 | 15 | 15 | 15 | 15 | 15 |
| CPJ-6976 | 6 | 6 | 6 | 6 | 6 | 6 | 6 | 6 |
| Irgacure 184 | 2.6 | 2.6 | 0 | 1.4 | 2.1 | 2.3 | 2.4 | 2.5 |
| Benzophenone | 0 | 0 | 1.1 | 0.5 | 0.25 | 0.15 | 0.1 | 0.05 |
| Irgacure 1035 | 0 | 0.2 | 0 | 0 | 0 | 0 | 0 | 0 |
| Properties | | | | | | | | |
| Ec (mJ/cm²) | 4.4 | 7.86 | 10.31 | 7.12 | 4.72 | 5.35 | 5.52 | 5.68 |
| Dp (mm) | 4.16 | 5.19 | 4.17 | 4.58 | 4.19 | 4.3 | 4.37 | 4.81 |
| E10 (mJ/cm²) | 48.8 | 54.1 | 113.3 | 63.2 | 51.3 | 54.9 | 54.4 | 45.4 |

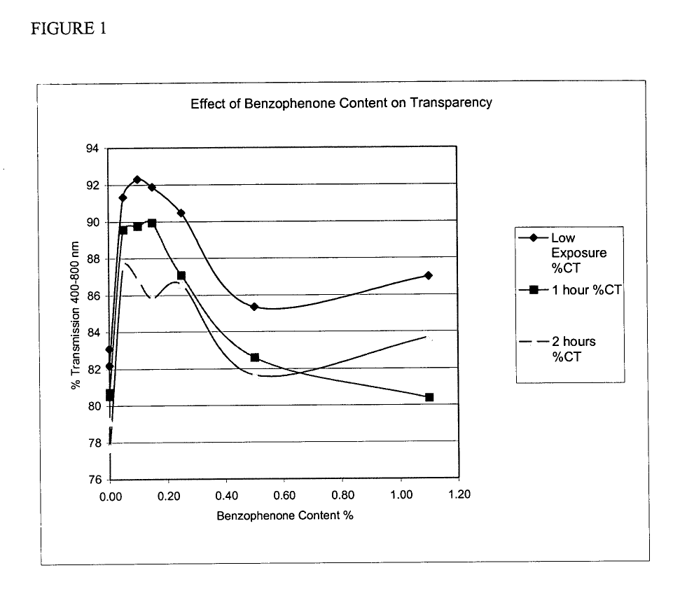

Each of the sample compositions above was mixed thoroughly and then weighed into the lid section of a VWR Polystyrene Disposable 60 by 15 mm Cat. No. 25384-060 petri dish. Approximately 15.0 grams of each sample composition was weighed out into 3 separate dishes, placed in a PCA (3D Systems 10 bulb unit using Phillips TLK/05 40W bulbs with approximately 15 hours of usage), and cured for 1.0 minutes from the top (which substantially hardened the composition) and ten minutes with the dish inverted on a raised glass plate using two bulbs for exposure. This provided the low cure exposed sample data. One sample each of the low cure examples were removed from the PCA. Then the remaining two samples of each example were clamped on an edge vertically in a large binder clip (BT Masterbrand™ Large Binder Clip) such that the sample would receive exposure from two sides. The samples were arranged in a circle on the PCA turntable so all would receive approximately the same exposure. All the remaining samples were exposed for 1 hour using a 10-bulb exposure. Next one of each of the examples was removed from the PCA. The remaining examples in the PCA were exposed for an additional hour. The thickness of the petri-dish flat surface is approximately 0.86 mm and the thickness of the samples in the petri dish (including the dish thickness) was approximately 5.4 mm. Each of the samples had varying levels of light scattering and color development after this exposure. Next an empty polystyrene dish was placed in a spectrophotometer (Cary UV 500) such that the bottom of an empty polystyrene dish was substantially vertical and normal to the sample beam of the spectrophotometer. The reference beam was against air. A baseline from 800 to 400 nm was run with the empty dish 1in this manner in order to eliminate surface reflection dispersion anomalies and absorption effects from the polystyrene dish over this wavelength range. In effect therefore the petri dish is a normalized control sample having 100% transparency over the wavelength range for the purposes of this evaluation. After the baseline was run, the samples were placed in the sample beam of the spectrophotometer with the flat of the dish vertical and substantially normal to the beam. A spectrum was measured for each 1 nm between 800 and 400 nm for all the samples (low exposure, 1 hour exposed, and 2 hour exposed) of each example composition. To minimize the contribution of light scattering, all the sample data was normalized to 100% exposure at 800 nm. Each of the samples exhibited a curve that started lower at 400 nm and increased along a curve till it was 100% at 800 nm that for the most part exhibited the color transparency of the sample. For each sample of 800 nm normalized data, the transmission values at each wavelength was summed and then divided by the transmission sum of the baseline petri dish and multiplied by 100 to obtain a Percent Color Transparency (%CT) number for the samples. Below the results are tabulated and they are graphed in FIG. 1.

TABLE 3

| | Benzophenone | Low Exposure | 1 hour | 2 hours |
|---|---|---|---|---|
| | Content | % CT | % CT | % CT |
| Ex. 1 | 1.10 | 87 | 80 | 84 |
| Ex. 2 | 0.50 | 85 | 83 | 82 |
| Ex. 3 | 0.25 | 90 | 87 | 87 |
| Ex. 4 | 0.15 | 92 | 90 | 86 |
| Ex. 5 | 0.10 | 92 | 90 | 87 |
| Ex. 6 | 0.05 | 91 | 90 | 88 |
| Comp. A | 0.00 | 82 | 81 | 78 |
| Comp. B | 0.00 | 83 | 81 | 79 |

Similar experiments were run employing a commercial composition Somos® 10120 (Available from DSM Inc) which does not contain benzophenone as Comparative Example C, and the following compositions as Examples 7, 8, and 9:

TABLE 4

| | Ex. 7 | Ex. 8 | Ex. 9 |
|---|---|---|---|
| Component | | | |
| Uvacure 1500 | 55.94 | 56.44 | 55.74 |
| Terathane 250 | 18.5 | 18.5 | 18.5 |
| Benzophenone | 0.75 | 1 | 0.75 |
| SR-399 | 13 | 13 | 13 |
| SR-9003 | 5 | 5 | 5 |
| IR-184 | 0.75 | 0 | 0.75 |
| CPI-6976 | 5 | 5 | 5 |
| Sliwet S-7600 | 0.05 | 0.05 | 0.05 |
| BYK-088 | 0.005 | 0.005 | 0.005 |
| Distilled Water | 1 | 1 | 1 |
| Polyvinylpyrrolidone | 0.005 | 0.005 | 0.005 |
| Longnox 10 | 0 | 0 | 0.2 |
| Properties | | | |
| Ec (mJ/cm\hat{ }2) | 10.1 | 12.3 | 10.7 |
| Dp (mm) | 6.4 | 6.5 | 6.5 |
| E10 (mJ/cm\hat{ }2) | 48.7 | 57.6 | 49.2 |

The E10 mJ/cm² value is a measure of photospeed (See also test methods below). The lower the E10 number in general the faster the photospeed. Both Examples 1 and 8 have only benzophenone as a free-radical intiator source but Example 1 has a slow photospeed of 113 mJ/cm² while Example 8 has a relatively fast photospeed of 57.6 mJ/cm². While not wishing to be limited by any particular theory, it is believed that the presence of the polyether polyol component provides a suitable hydrogen abstraction source for the benzophenone, thereby enhancing the photospeed of Example 8 relative to Example 1 which does not have a polyether polyol component in the liquid.

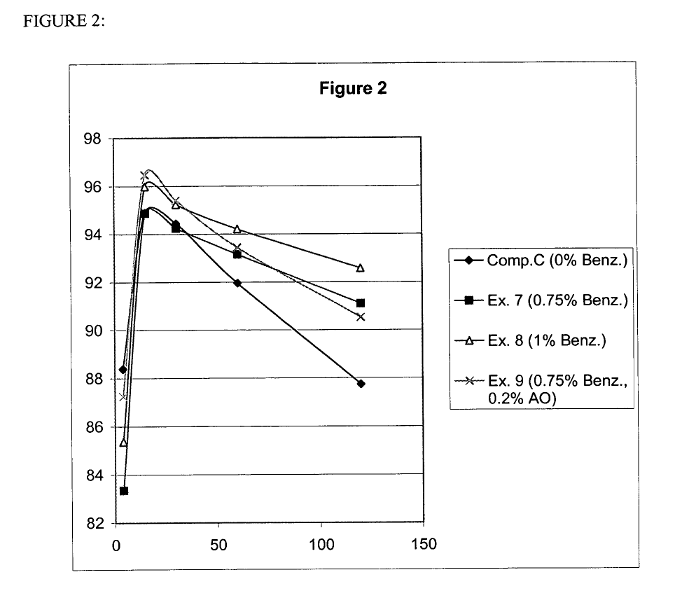

When the Comparative Example (Somos 10120) and Example 7, 8, and 9 petri dish samples were prepared and exposed in a PCA (bulbs with 70 hours usage) as described above for various times, and then the sample data was handled in a similar manner (normalizing at 800 nm, summing over the wavelengths, and converted to a Percent Color Transparency, %CT) the results are tabulated below (where the low exposure data is estimated at 4 minutes). The Color Transparency measurements were made two days after exposure, allowing transient color effects from UV exposure to dissapate. The results are also shown in FIG. 2. Note that samples containing benzophenone have greater colorfastness(attain lower color after longer term light exposures) and that samples containing benxophenone and another free radical photoinitiator have improved colorfastness as well as faster photospeeds.

TABLE 5

| | | | | Ex. 9 (0.75% |
|---|---|---|---|---|
| Exposure | Comp. C | Ex. 7 | Ex. 8 | Benz., |
| Time (min) | (0% Benz.) | (0.75% Benz.) | (1% Benz.) | 0.2% AO) |
| 4 | 88 | 83 | 85 | 87 |
| 15 | 95 | 95 | 96 | 96 |
| 30 | 94 | 94 | 95 | 95 |
| 60 | 92 | 93 | 94 | 93 |
| 120 | 88 | 91 | 93 | 91 |

### Test Methods: Ec, Dp, and E10

The Photoproperties Ec (mJ/cm²), Dp (mm), and E10 (ml/cm²) represent the photoresponse (in this case thickness of layer formed) of a particular formulation to exposure by a single wavelengh or range of wavelengths. In the instant Examples and Comparative Examples, at least 20 grams of composition was poured into a 100 mm diameter petri-dish and allowed to equilibrate to approximately 30° C. and 30% RH. The samples were then scanned in a line-by-line fashion using a focused laser beam of approximately 100-140 mW. The laser, a frequency tripled YAG laser, had an output wavelength of 354.7 run and was pulsed at 80 KHz. The exposures were made in a square pattern approximately 20 mm by 20 mm. Six individual exposures were made at near constant laser power but at various scan speeds. The parallel scan lines making up each exposure were drawn approximately 50 um apart. Based upon knowledge of the diameter of the focused beam at the liquid surface, the scan speed, the laser power, and the scan spacing, the summation of exposure mJ/cm² was calculated. Each square was allowed to float on the surface of the petri-dish for approximately 15 minutes. Then the squares were blotted and a thickness measurement was taken using Mitutoyo NTO25-8″C spring loaded Absolute Digimatic calipers. When the natural log of the exposures is plotted against the measured thickness a least squares fit line can be drawn. The Dp (mm) is the slope of the least squares fit line. The Ec (mJ/cm²) is the X-axis crossing point (Y=0) of the line. And the E10 is the energy necessary to produce a layer approximately 10 mils (254 um) thick. In general the lower the E10 number, the faster the photospeed of the composition (especially when producing a 10 mil exposure). In one embodiment, the present compositions have an E10 number of less than 150 mJ/cm², for instance less than 100 mJ/cm², less than 75 mJ/cm², less than 60 mJ/cm², or less than 50 mJ/cm²

Having described specific embodiments of the present invention, it will be understood that many modifications thereof will readily be apparent to those skilled in the art, and it is intended therefore that this invention is limited only by the spirit and scope of the following claims.

What is claimed is:

1. A composition comprising, as pre-mixture ingredients,
(i) at least one free radical curable component;
(ii) at least one cationically curable component;
(iii) at least one free radical photoinitiator selected from the group consisting of benzophenones; and
(iv) at least one other free radical photoinitiator not selected from the group consisting of benzophenones.

2. The composition according to claim 1, wherein said at least one photoinitiator is benzophenone.

3. The composition according to any one of claims 1-2, wherein said at least one other photoinitiator is 1-hydroxycyclohexyl phenyl ketone.

4. The composition according to any one of claims 1-3, wherein the weight ratio of said at least one photoinitiator to said at least one other photoinitiator is less than 0.50.

5. The composition according to any one of claims 1-3, wherein the weight ratio of said at least one photoinitiator to said at least one other photoinitiator is less than 0.05.

6. The composition according to any one of claims 1-5, wherein the weight ratio of said at least one photoinitiator to said at least one other photoinitiator is at least 0.01.

7. The composition according to any one of claims 1-6, wherein said at least one cationically curable component includes a cycloaliphatic diepoxide.

8. The composition according to any one of claims 1-7, wherein said at least one cationically curable component includes an oxetane compound.

9. The composition according to any one of claims 1-8, wherein said at least one free radical curable component includes a (meth)acrylate functional pentaerythritol derivative.

10. The composition according to claim 9, wherein said pentaerythritol derivative is monohydroxy dipentaerythriol pentaacrylate.

11. The composition according to any one of claims 1-10, wherein said at least one free radical curable component includes a (meth)acrylate-functional neopentylglycol derivative.

12. The composition according to any one of claims 1-11, wherein said composition comprises a polyol.

13. The composition according to claim 12, wherein said polyol is a polyether polyol.

14. The composition according to claim 12, wherein said polyol is a polyester polyol.

15. The composition according to any one of claims 12-14, wherein said hydroxy-functional component has a molecular weight in the range of 200-2500 g/mol.

16. The composition according to any one of claims 1-15, wherein said composition comprises less than 1.5 wt %, relative to the total composition, of said at least one photoinitiator.

17. The composition according to any one of claims 1-15, wherein said composition comprises less than 0.5 wt %, relative to the total composition, of said at least one photoinitiator.

18. The composition according to any one of claims 1-17, wherein said composition comprises, relative to the total weight of said composition, 5-35 wt % of said at least one free radical curable component.

19. The composition according to any one of claims 1-18, wherein said composition comprises, relative to the total weight of said composition, 45-90 wt % of said at least one cationically curable component.

20. The composition according to any one of claims 1-19, wherein said composition comprises at least 5 wt % of a hydroxy-functional component.

21. The composition according to claim 20, wherein said hydroxy-functional component is absent epoxy groups, oxetane groups, and free radical curable groups.

22. The composition according to any one of claims 1-21, wherein said composition has an E10 number of less than 60 mJ/cm².

23. A composition comprising, as pre-mixture ingredients,
(i) at least one free radical curable component; and
(ii) 0.01 to less than 0.50 wt % of a free radical photoinitiator selected from the group consisting of benzophenones.

24. A process for forming a three-dimensional object comprising rapid prototyping the composition according to any one of claims 1-23.

25. An article obtainable by the process of claim 24.

26. A process for improving the color stability of an article formed at least in part by curing a composition, wherein the process comprises including a photoinitiator selected from the group of benzophenones in the composition prior to cure.

27. The process of claim 26, wherein said composition comprises at least one other photoinitiator not selected from the group consisting of benzophenones.
